(19) United States
(12) Patent Application Publication
(10) Pub. No.: US 2014/0160018 A1
(43) Pub. Date: Jun. 12, 2014

(54) PROJECTOR SYSTEM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YI-YING CHEN, New Taipei (TW); CHIU-HSIUNG LIN, New Taipei (TW); WEI-GUO XIAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/968,380

(22) Filed: Aug. 15, 2013

(30) Foreign Application Priority Data
Dec. 6, 2012 (CN) 2012105181150

(51) Int. Cl. G06F 3/033

(52) U.S. Cl. CPC G06F 3/033
USPC 345/157

(57) ABSTRACT

An image projection system includes a projector connected to a host computer to display images on a projection screen, an image capture device, and an operation pen. The operation pen emits a laser beam and has buttons. The image capturing device captures a photo with a point part of the projected image on which the laser beam falls. The host computer compares the photo with the image being supplied by the host computer to determine the point part being pointed by the laser beam, receives wireless control signals from the operation pen, and executes actions of buttons of the operation pen.

### BACKGROUND

1. Technical Field

The present disclosure relates to a projector system.

2. Description of Related Art

A typical projector projects images from a computer to a wall to enlarge the image for sharing with people in a conference, a lecture or the like. Conventionally, a user controls the images on the computer by a keyboard or a mouse connected to the computer to control the projected images on the wall indirectly. Thus, the user must stand before the computer when the user controls the enlarged images, which is inconvenient for the user.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a projector system in accordance with an exemplary embodiment of the present disclosure.

FIG. 2 is cross-sectional view of an operation pen of the projector system in FIG. 1.

FIG. 3 is a block diagram of a host computer of the projector system in FIG. 1.

### DETAILED DESCRIPTION

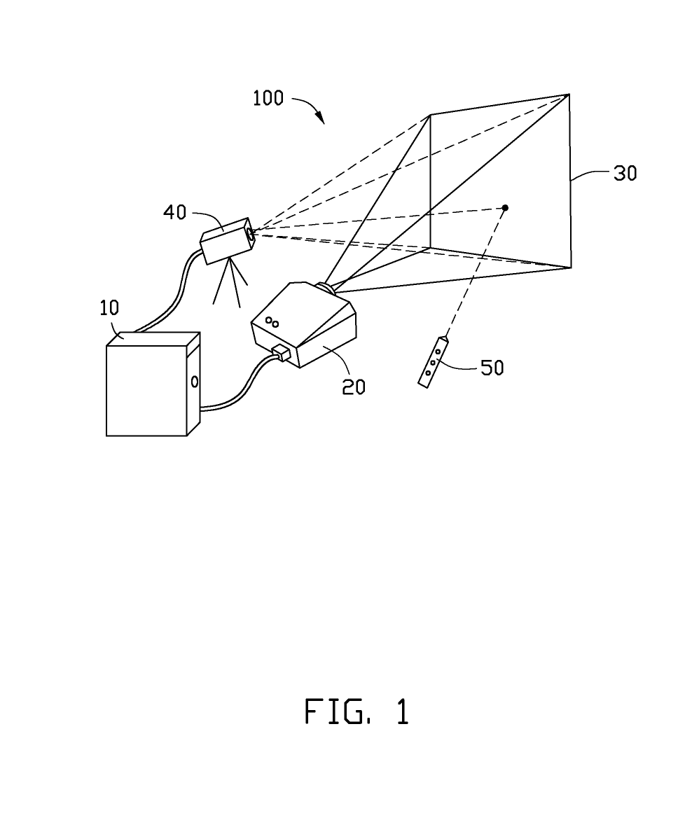

Referring to FIG. 1, a projector system 100 in accordance with an exemplary embodiment is illustrated. The projector system 100 includes a host computer 10, a projector 20, a projection screen 30, an image capturing device 40 and an operation pen 50.

The projector 20 is connected to the host computer 10 such as a personal computer to project an image on the projection screen 30. The image is supplied by the host computer 10 and may be images of objects, words, or videos.

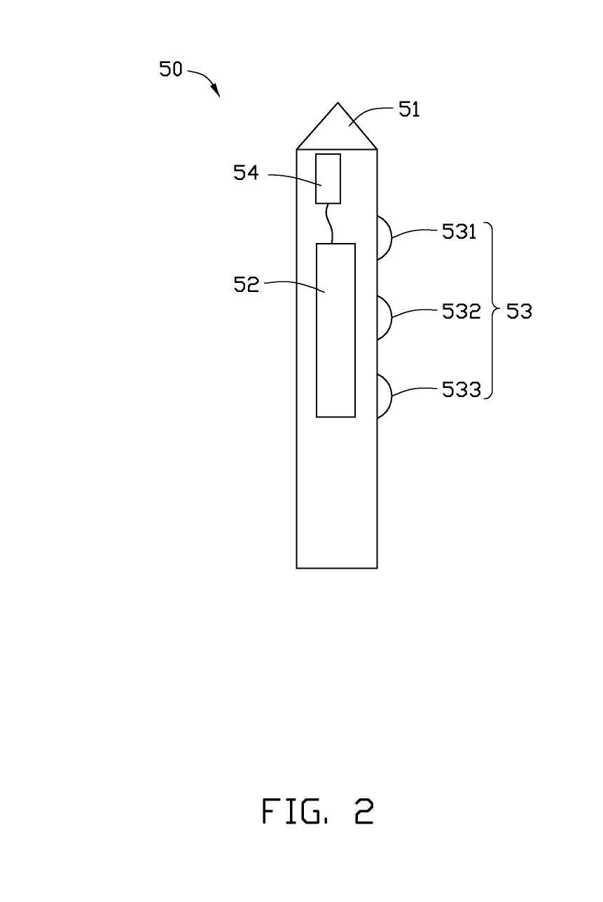

The operation pen 50 in the hands of a user controls the image displayed on the projection screen 30, such as playing a video, editing a file, drawing, marking or flipping pages. Referring to FIG. 2, the operation pen 50 comprises a laser 51, a processor 52, a number of buttons 53 and a wireless transmitter 54. The laser 51, the buttons 53 and the wireless transmitter 54 are all electronically connected to the processor 52. When one of the buttons 53 is pressed, the processor 52 controls the laser 51 to emit a laser beam and the wireless transmitter 54 to generate a control signal corresponding to the button 53. Users operate the operation pen 50 to control the laser beam to point to a part of the projected image to mark the part where the users desire to carry out an operation, and a laser point is visible on the part being pointed at. The host computer 10 is configured to receive the control signal transmitted from the operation pen 50 and perform an operation such as flipping pages, double clicking or underlining in relation to the pointed part of the image.

In the embodiment, the buttons 53 serve as a mouse of the host computer 10. The buttons 53 comprises a first button 531, a second button 532 and a third button 533. The function of the first button 531 is similar to the function of the left button of the mouse, that is, the first button 531 is pressed to mark a part of the image or double clicked to run a marked application, for example. The function of the second button 532 is similar to the function of the right button of the mouse, that is, the second button 532 is pressed to display an operation menu bar in relation to the marked part of the image. The third button 533 is a roller which can be rolled forward or backward, and the function of the third button 533 is similar to the function of the wheel on the mouse, that is, the third button 533 is rolled forward or backward to scroll the content of the image displayed on the projection screen 30 forward or backward.

The image capturing device 40 is connected to the host computer 10. The image capturing device 40 captures a photo of the projection screen 30 and sends the captured photo to the host computer 10. In the embodiment, the image capturing device 40 comprises a focus adjustment to adjust the focal length of the image capturing device 40, thus enabling the image capturing device 40 to capture the whole area of the projection screen 30. The captured photo includes the visible laser point on the projection screen 30.

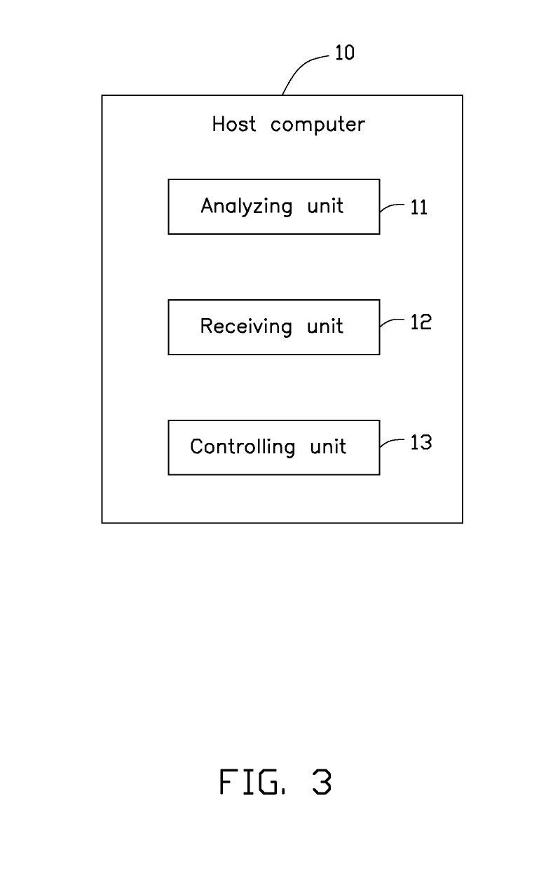

Referring to FIG. 3, the host computer 10 includes a contrasting unit 11, a receiving unit 12 and a controlling unit 13.

The analyzing unit 11 is configured to compare the captured image with the image being supplied by the host computer 10 to determine the part which is being pointed at by the laser beam of the operation pen 50. The receiving unit 12 is configured to receive the wireless control signals transmitted by the operation pen 50. The controlling unit 13 is configured to perform an operation in relation to the part being pointed at in response to the received control signals. For example, when the part being pointed at is an application icon, and the received control signal is a click signal generated by the first button 531, the controlling unit 13 marks (selects) the application icon. When the received control signal is a double click signal generated by the first button 531, the controlling unit 13 opens and runs the application corresponding to the application icon. When the received control signal is a click signal generated by the second button 532, the controlling unit 13 displays an operation menu bar on the display screen in relation the application icon.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A project system, comprising:
a host computer supplying images to be displayed;
a projector connected to the host computer to project an image from the host computer to be displayed on a projection screen;
an operation pen emitting a laser beam to point to a part of the projected image to mark the part where users desire to carry out an operation and control the image displayed on the projection screen, wherein a laser point is visible on the part being pointed at;
an image capturing device capturing a photo of the projection screen and sending the captured photo to the host computer, wherein the captured photo comprises the projection image and a visible laser point on the part being pointed;
wherein the host computer comprise an analyzing unit, a receiving unit, and a controlling unit; the analyzing unit is configured to compare the captured photo with the image being supplied by the host computer to determine the part which is being pointed at by the laser beam; the receiving unit is configured to receive control signals transmitted by the operation pen; the controlling unit is configured to perform an operation in relation to the part being pointed according to the control signals.

2. The projector system as described in claim 1, wherein the image capturing device further comprises a focus adjustment to adjust the focal length of the image capturing device to enable the image capturing device to capture the whole area of the projection screen.

3. The projector system as described in claim 1, wherein the operation pen comprises a laser, a processor, a plurality of buttons operable by users and a wireless transmitter; the laser, the buttons and the wireless transmitter are all electronically connected to the processor; the processor controls the laser to emit the laser beam to point the part of the image where the user desires to carry out an operation and the wireless transmitter to transmit the control signals according to an operated one of the buttons.

4. The projector system as described in claim 3, wherein the buttons comprises a first button, a second button and a third button, the first button is pressable to select the part pointed by the laser beam or doubly clicked to run an application in relation to the part pointed by the laser beam; the second button is pressable to display an operation menu bar in relation to the part pointed by the laser beam; and the third button is scrollable to scroll the image projected on the projection screen forward or backward.

5. The projector system as described in claim 1, wherein the point part by the laser beam is an icon.
